(19) United States
(12) Patent Application Publication
(10) Pub. No.: US 2013/0231421 A1
(43) Pub. Date: Sep. 5, 2013

(54) STARCH-BASED THERMOPLASTIC COMPOSITES

(71) Applicant: INDUSTRIAL TECHNOLOGY RESEARCH INSTITUTE, (US)

(72) Inventors: Sheng-Ju Liao, Hsinchu City (TW); Chien-Ming Chen, Taoyuan County (TW); Chih-Jen Chang, Miaoli County (TW); Yao-Chu Chung, Kaohsiung City (TW); Cheng-Feng Liao, Pingtung County (TW); Hsieh-Yung Chang, Taoyuan County (TW)

(73) Assignee: INDUSTRIAL TECHNOLOGY RESEARCH INSTITUTE, Hsinchu County (TW)

(21) Appl. No.: 13/867,030

(22) Filed: Apr. 19, 2013

(30) Foreign Application Priority Data
Sep. 6, 2010 (TW) 099130013

(51) Int. Cl. C08L 3/04

(52) U.S. Cl. CPC C08L 3/04
USPC 524/47

(57) ABSTRACT

In an embodiment, a starch-based thermoplastic composite is provided. The starch-based thermoplastic composite includes enzyme-degraded thermoplastic starch (TPS) having a debranching rate of 40-90%, polycarbonate (PC) and acrylonitrile butadiene styrene (ABS), wherein the polycarbonate (PC) has a weight ratio of 15-60% in the starch-based thermoplastic composite. The starch-based thermoplastic composite further includes an impact modifier and a compatibilizer.

### CROSS REFERENCE TO RELATED APPLICATIONS

This application is a Continuation-In-Part of pending U.S. patent application Ser. No. 13/040,266, filed on Mar. 4, 2011, and entitled “Starch-based thermoplastic composites”, which claims priority of Taiwan Patent Application No. 99130013, filed on Sep. 6, 2010, the entirety of which is incorporated by reference herein.

### TECHNICAL FIELD

The technical field relates to a starch-based thermoplastic composite.

### BACKGROUND

Generally, the thermal stability of materials from a biomass is low. When they are blended and processed with petrochemical engineering plastics, due to poor compatibility and large differences in melt viscosities therebetween, some phenomena, for example uneven distribution, stratification and aggregation occur, such that melt processing cannot be conducted.

The hydrogen bond of starch is destroyed by conducting plasticizers, for example polyols, then, in the starch molecule, chain entanglement and chain motion occur, achieving thermal plasticization characteristics. Thermoplastic starch (TPS), as other synthetic polymers with fluidic characteristics, is applicable to be used for thermoplastic molding and extrusion processing technology. However, lack of mechanical strength, pure thermoplastic starch materials have limited applications. Therefore, a follow-up blending system has been developed.

The ICT industry has a strong demand for green and recycled materials which can reduce carbon emission. If new environmental protection materials consistent with EPA EPEAT green purchasing specifications (biomass content exceeding 10%) or Japan Bioplastics Association (JBPA) BiomassPla mark (Biomass content exceeding 25%) can be developed, 15 to 40 million tons of plastic or plastic-related materials consumption of petrochemical materials can be reduced per year.

### SUMMARY

One embodiment of the disclosure provides a starch-based thermoplastic composite, comprising: enzyme-degraded thermoplastic starch (TPS) having a debranching rate of 40-90%; polycarbonate (PC), wherein the polycarbonate (PC) has a weight ratio of 15-60% in the starch-based thermoplastic composite; and acrylonitrile butadiene styrene (ABS).

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawing, wherein:

FIGS. 1a-1d exhibit size and shape of starch in the starch-based biomass composite of the disclosure;

FIG. 2 shows a relationship between compactness and particle size of starch in the starch-based biomass composite of the disclosure;

FIG. 3 shows a cosmetics case fabricated by the starch-based biomass composite of the disclosure;

FIG. 4 shows a cartridge case fabricated by the starch-based biomass composite of the disclosure;

FIG. 5 shows a thick phone case fabricated by the starch-based biomass composite of the disclosure; and

FIG. 6 shows a twinshot phone case fabricated by the starch-based biomass composite of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides a starch-based thermoplastic composite comprising enzyme-degraded thermoplastic starch (TPS) having a debranching rate of 40-90%, polycarbonate (PC) and acrylonitrile butadiene styrene (ABS). The polycarbonate (PC) has a weight ratio of 15-60% in the disclosed starch-based thermoplastic composite. In another embodiment, the polycarbonate (PC) has a weight ratio of 30-45% in the disclosed starch-based thermoplastic composite.

In one embodiment, the enzyme-degraded thermoplastic starch (TPS) is prepared by the method in TW Pat. No. 1283167 “The preparation of enzymatic degradable starch and applications thereof”, the entirety of which is incorporated by reference herein.

In one embodiment, the enzyme-degraded thermoplastic starch (TPS) has a debranching rate of about 40-60%. The original starch structure with high-density branch chains and high end-crystallization is decomposed utilizing a specific enzyme, for example pullulanse or α-isoamylase, to cut the α-1,6 bonding of the branch chains to form the enzyme-degraded thermoplastic starch (TPS) with chain entanglement and plasticity property. The enzyme-degraded thermoplastic starch (TPS) has a weight ratio of 10-70% in the disclosed starch-based thermoplastic composite. In another embodiment, the enzyme-degraded thermoplastic starch (TPS) has a weight ratio of 10-35%, for example exceeding or equal to 25%, in the disclosed starch-based thermoplastic composite. 95% of the enzyme-degraded thermoplastic starch (TPS) has a particle size less than 1.5 μm.

The disclosure selects polyols having solubility similar to starch, water and high-temperature resistant natural plasticizers to prepare a complex formulation with starch. After granulation, thermoplastic starch particles are therefore prepared. The melt viscosity of the thermoplastic starch is adjustable by altering the plasticizers and their contents.

In one embodiment, the acrylonitrile butadiene styrene (ABS) has a weight ratio of 15-60% in the disclosed starch-based thermoplastic composite. In another embodiment, the acrylonitrile butadiene styrene (ABS) has a weight ratio of 30-45% in the disclosed starch-based thermoplastic composite.

In one embodiment, the disclosed starch-based thermoplastic composite further comprises an impact modifier, for example metallocene-based polyethylene (MPE), polypropylene (PP), poly(butadiene-styrene) (PBS), thermoplastic polyurethane (TPU), styrene-ethylene/butylene-styrene (SEBS), styrene-ethylene/propylene-styrene (SEPS), methacrylated butadiene-styrene (MBS), thermoplastic elastomers (TPE), high-rubber content acrylonitrile butadiene styrene (ABS), polycarbonate (PC) or a combination thereof. The impact modifier has a weight ratio of 2-45%, in the disclosed starch-based thermoplastic composite. In another embodiment, the impact modifier has a weight ratio of 5-30% in the disclosed starch-based thermoplastic composite.

The disclosure optionally includes the impact modifier compatible with the polymer substrate and starch to improve the toughness of the substrate. Also, due to the improved capacity by the impact modifier, after optimally adjusting of the composition, the physical properties of the composite were improved.

In one embodiment, the disclosed starch-based thermoplastic composite can further comprise a compatibilizer, for example polyethylene-g-maleic anhydride (PE-g-MA), polyethylene-g-glycidyl methacrylate (PE-g-GMA), ethylenevinylacetate-g-maleic anhydride (EVA-g-MA), polypropylene-g-maleic anhydride (PP-g-MA), polystyrene-g-maleic anhydride (PS-g-MA), acrylonitrile butadiene styrene-g-maleic anhydride (ABS-g-MA), styrene maleic anhydride (SMA), polycarbonate (PC) or a combination thereof. The compatibilizer has a weight ratio of 0.1-20% in the disclosed starch-based thermoplastic composite. In another embodiment, the compatibilizer has a weight ratio of 3-7% in the disclosed starch-based thermoplastic composite.

The disclosure optionally includes the compatibilizer of the disclosure is one compatible with the polymer substrate and capable of reaction with hydroxy group (—OH) on the starch surface to reduce interfacial tension, thereby improving the physical properties of the composite.

The disclosure utilizes controlled end-cap technology comprising starch debranching degradation and functional group modification to give starch some properties, for example rheological processability and low moisture absorption, then utilizes the compatible interface structure formed thereof, reinforced structure and thermal stability mechanism to address long-standing issues, for example the compatibility, processability and degradation between biomass materials and petrochemical materials. Commercially available plastic parts which mainly comprise petrochemical engineering plastics, for example high impact polystyrene (HIPS), acrylonitrile butadiene styrene (ABS) and polycarbonate/acrylonitrile butadiene styrene (PC/ABS), of ICT housing products can be replaced by the developed high-efficiency starch-based biomass composite with an enzyme-degraded thermoplastic starch (TPS) content exceeding 25% and a heat deflection temperature (HDT) exceeding 85° C.

### EXAMPLE 1

Analysis of Physical Properties of the Starch-Based Thermoplastic Composite (1)

Polycarbonate (PC, purchased from Mitsubishi Corporation, model: H3000) was utilized as a compatibilizer and an impact modifier for a thermoplastic starch (TPS)/acrylonitrile butadiene styrene (ABS) biomass composite system (TPS was prepared by the method in TW Pat. No. 1283167 “The preparation of enzymatic degradable starch and applications thereof”, the entirety of which is incorporated by reference herein, and ABS was purchased from Grand Pacific Petrochemical Corporation, model: D100). Melt blending was performed in a twin screw extruder under a processing temperature of 227° C. and a screw rotation speed of 100 rpm to prepare TPS/(PC/ABS) particles. The viscosity of the system can be effectively reduced by adding TPS. The extrusion strip with a smooth surface and improved toughness exhibited a light yellow color.

The analysis of the physical properties of the TPS/ABS biomass composite system containing the PC with various ratios is shown in Table 1. Physical properties comprise impact resistance, thermal deformation resistance and mobility. The results indicate that the mechanical properties, for example impact strength (the notched specimen and un-notched specimen were respectively utilized), tensile strength (TS), elongation, flexural strength (FS), flexural modules (FM) and heat deflection temperature (HDT), of the PC/TPS/ABS biomass composite were apparently improved. After PC was conducted, the mobility, for example melt index (MI), of the biomass composite was also apparently improved; which is suitable for use in forming of thin injection products.

TABLE 1

| Mechanical | | | | |
|---|---|---|---|---|
| properties | AT-54 | PAT-06 | PAT-05 | PAT-04 |
| TPS content | 25% | 25% | 25% | 25% |
| PC content | 0% | 15% | 30% | 45% |
| ABS content | 70% | 60% | 45% | 30% |
| Impact strength | 10.81 | 6.5 | 11.4 | 9.6 |
| (notched | | | | |
| specimen) | | | | |
| (kgf-cm/cm) | | | | |
| Impact strength | — | 127 | 164 | 183 |
| (un-notched | | | | |
| specimen) | | | | |
| (kgf-cm/cm) | | | | |
| Tensile strength | 297 | 356 | 384 | 420 |
| (TS) | | | | |
| (kgf/cm²) | | | | |
| Elongation | 2.5 | 11 | 12 | 18 |
| (%) | | | | |
| Flexural strength | 392 | 556 | 618 | 694 |
| (FS) | | | | |
| (kgf/cm²) | | | | |
| Flexural modules | 15604 | 19048 | 20368 | 21728 |
| (FM) | | | | |
| (kgf-cm/cm) | | | | |
| Heat deflection | 74 | 70 | 85 | 97 |
| temperature | | | | |
| (HDT) | | | | |
| (° C./264 psi) | | | | |
| Melt index | 0.05* | 22 | 21 | 22 |
| (MI) | | | | |
| (g/10 min, 230° C., | | | | |
| 5 kg) | | | | |

*MI test condition: g/10 min, 200° C., 5 kg

### EXAMPLE 2

Analysis of Physical Properties of the Starch-Based Thermoplastic Composite (2)

S-grade PC (purchased from Mitsubishi Corporation, model: S3000) and H-grade PC (purchased from Mitsubishi Corporation, model: H3000) were respectively added to a TPS/ABS biomass composite system (TPS was prepared by the method in TW Pat. No. 1283167 “The preparation of enzymatic degradable starch and applications thereof”, and ABS was purchased from Grand Pacific Petrochemical Corporation, model: D100). The results shown in Table 2 indicate that the impact strength and rigidity of the biomass composite were improved by adding S-grade PC. Particularly, the impact strength of PAT-37 achieved 18.13 kgf-cm/cm and the heat deflection temperature thereof achieved 101° C. The high-efficiency starch-based biomass composite is suitable for use in plastic parts of ICT housing products.

TABLE 2

| Mechanical | | | | |
|---|---|---|---|---|
| properties | PAT-05 | PAT-04 | PAT-33 | PAT-37 |
| TPS content | 25% | 25% | 25% | 25% |
| PC content | 30% | 45% | 30% | 45% |
| ABS content | 45% | 30% | 45% | 30% |
| PC grade | H | H | S | S |
| Impact strength | 11.4 | 9.6 | 12.34 | 18.13 |
| (notched | | | | |
| specimen) | | | | |
| (kgf-cm/cm) | | | | |
| Tensile strength | 384 | 420 | 411 | 475 |
| (TS) | | | | |
| (kgf/cm²) | | | | |
| Elongation | 12 | 18 | 5 | 9 |
| (%) | | | | |
| Flexural strength | 618 | 694 | 616 | 745 |
| (FS) | | | | |
| (kgf/cm²) | | | | |
| Flexural modules | 20368 | 21728 | 21122 | 23732 |
| (FM) | | | | |
| (kgf-cm/cm) | | | | |
| Heat deflection | 85 | 97 | 86 | 101 |
| temperature | | | | |
| (HDT) | | | | |
| (° C./264 psi) | | | | |
| Melt index | 21 | 22 | 10 | 11 |
| (MI) | | | | |
| (g/10 min, 230° C., | | | | |
| 5 kg) | | | | |

### EXAMPLE 3

Starch Distribution Profile in the Starch-Based Thermoplastic Composite

PC (purchased from Mitsubishi Corporation, model: S3000) was utilized as an impact modifier for a TPS/ABS biomass composite system (TPS was prepared by the method in TW Pat. No. 1283167 “The preparation of enzymatic degradable starch and applications thereof”, and ABS was purchased from Grand Pacific Petrochemical Corporation, model: D100). Various ratios (25%, 35%, 50% and 70%) of TPS and PC/ABS were added and melt-blended in a twin screw extruder under a processing temperature of 190-230° C. and a screw rotation speed of 50-200 rpm to prepare a 70% TPS/(PC/ABS) biomass composite masterbatch.

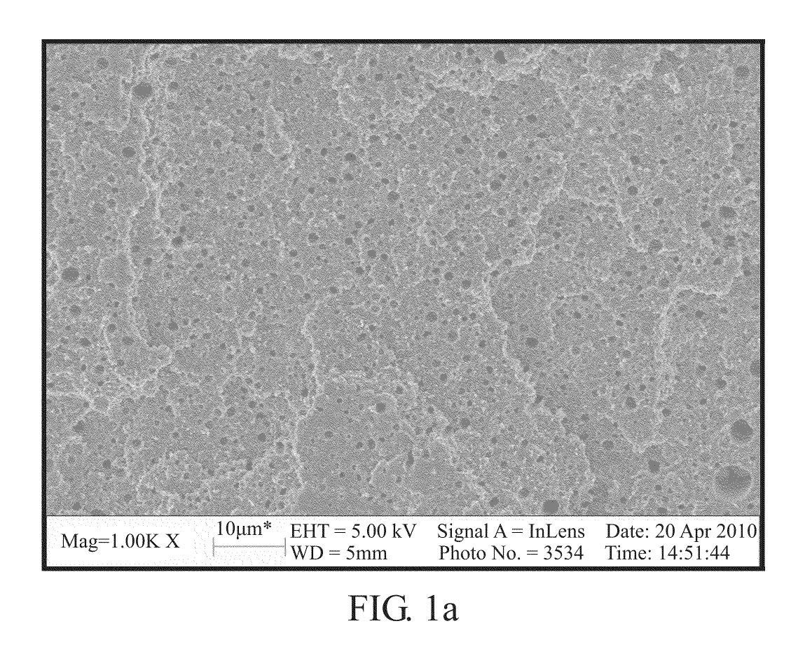

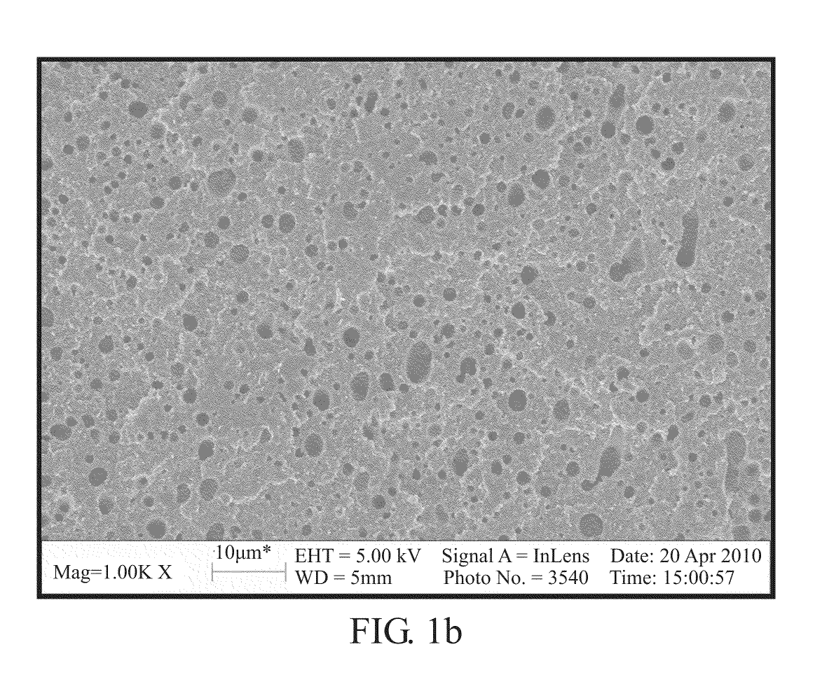

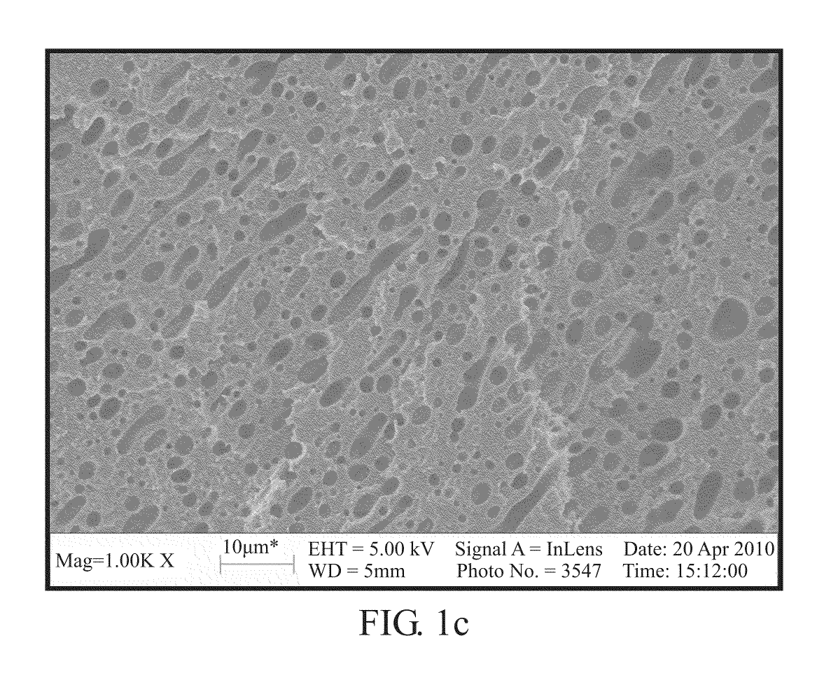

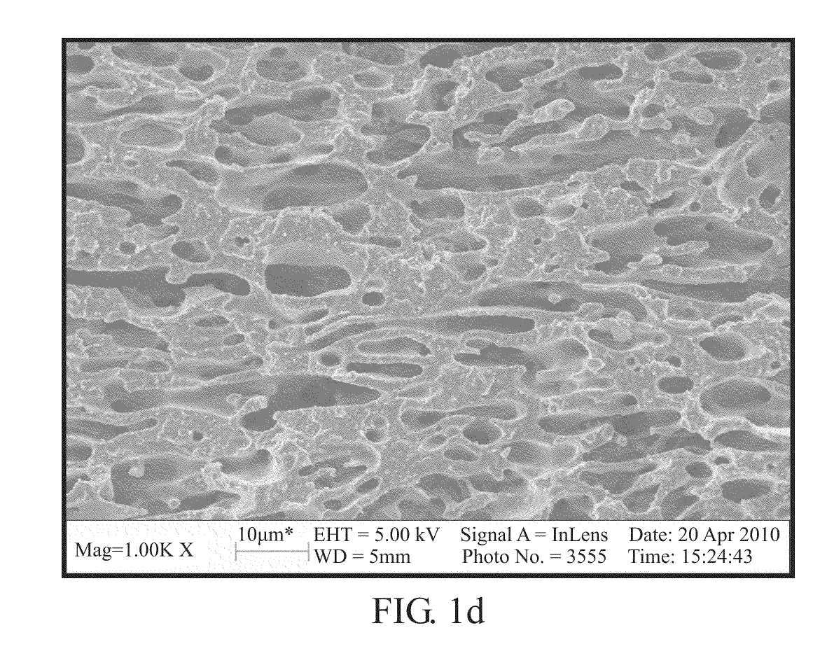

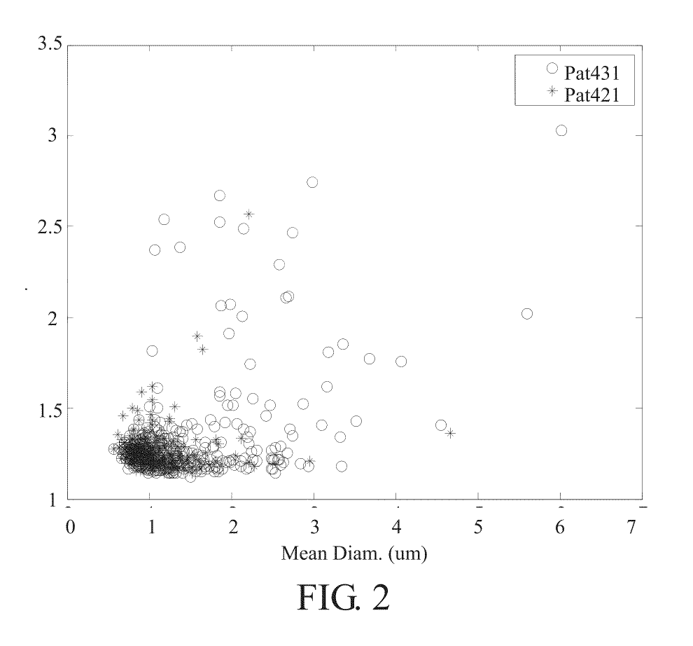

The SEM analytic results respectively shown in FIG. 1a (25% TPS), FIG. 1b (35% TPS), FIG. 1c (50% TPS) and FIG. 1d (70% TPS) indicate that as the TPS content was increased, the domain size thereof was increased due to aggregation, while altering from a circle to a long and narrow shape. When the TPS content was increased to 70%, a co-continuous phase was formed. Additionally, FIG. 2 shows that when the particle size of the starch in the TPS/(PC/ABS) composite was small and close to a circular shape, the impact strength of the composite was effectively improved. For example, the impact strength of Pat431 composite (containing 35% TPS) was 4.3 kgf-cm/cm, however, the impact strength of Pat421 composite (containing 25% TPS) was substantially increased to 18.1 kgf-cm/cm due to smaller TPS particles and a shape being much closer to circular shape. The particle size of 95% TPS was less than 1.5 μm.

### EXAMPLE 4

Injection Products of the Starch-Based Thermoplastic Composite

The high-efficiency starch-based biomass composite was injected from an injection molding machine with a processing temperature of 190-230° C. to form various prototyping products. The possibility of applications on housing materials of electronic and peripheral devices was validated in Table 3. High impact polystyrene (HIPS) was purchased from Chi Mei Corporation (model: PH-88-S). ABS was purchased from Grand Pacific Petrochemical Corporation (model: D100). PC was purchased from Mitsubishi Corporation (model: S3000).

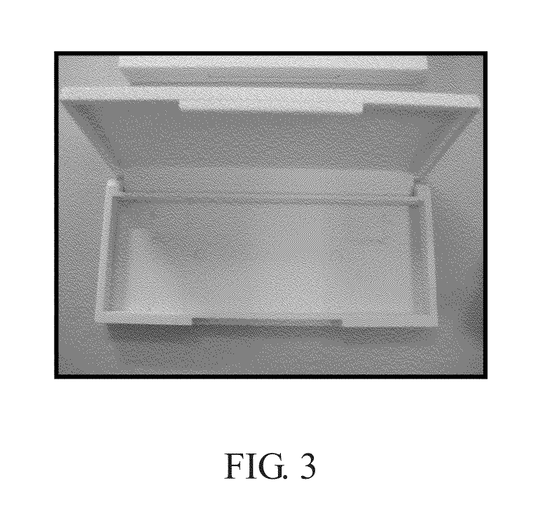

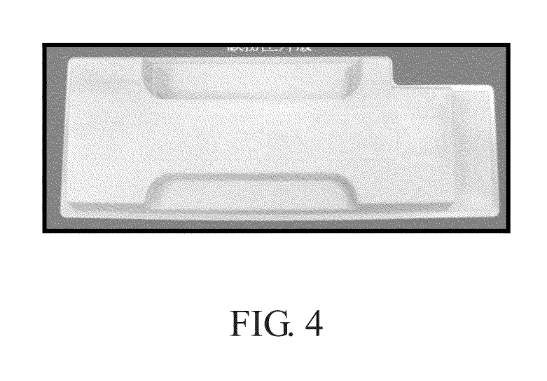

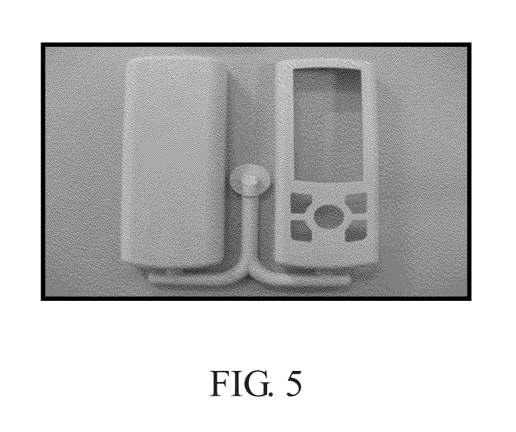

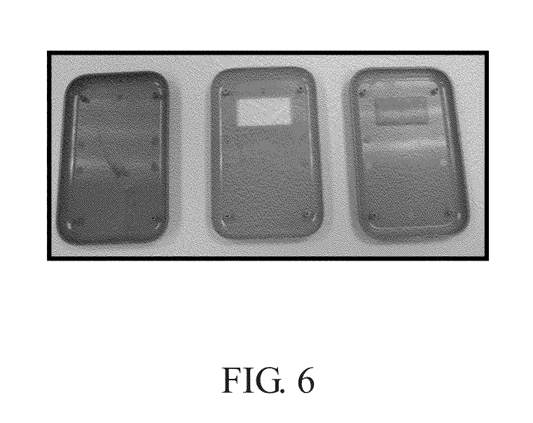

TABLE 3

| | | | ABS-54 | PAT-37 |
|---|---|---|---|---|
| | ST-01 | ABS-06 | (Thick phone | (Twinshot |
| | (Cosmetics | (Cartridge case, | case, as shown | phone case, as |
| Mechanical | case, as shown | as shown in | in FIG. 5) | shown in FIG. 6) |
| properties | in FIG. 3) | FIG. 4) | (1.2 mm-2.2 mm) | (0.7 mm) |
| TPS content | 30% | 25% | 25% | 25% |
| Polymer matrix | HIPS | ABS | ABS | PC/ABS |
| Impact strength | 5.64 | 4.33 | 10.81 | 18.13 |
| (kgf-cm/cm) | | | | |
| Tensile strength | 158 | 299 | 297 | 475 |
| (TS) | | | | |
| (kgf/cm²) | | | | |
| Elongation | 2.7 | 20.0 | 2.5 | 9 |
| (%) | | | | |
| Flexural strength | 287 | — | 392 | 745 |
| (FS) | | | | |
| (kgf/cm²) | | | | |
| Flexural modules | 18582 | — | 15604 | 23732 |
| (FM) | | | | |
| (kgf-cm/cm) | | | | |
| Heat deflection | 67 | — | 74 | 101 |
| temperature | | | | |
| (HDT) | | | | |
| (° C./264 psi) | | | | |
| Melt index | — | — | 0.05 | 11 |
| (MI) | | | | |
| (g/10 min, 230° C., | | | | |
| 5 kg) | | | | |

It will be apparent to those skilled in the art that various modifications and variations can be made to the disclosed embodiments. It is intended that the specification and examples be considered as exemplary only, with the true scope of the disclosure being indicated by the following claims and their equivalents.

What is claimed is:

1. A starch-based thermoplastic composite, comprising:
enzyme-degraded thermoplastic starch (TPS) having a debranching rate of 40-90%;
polycarbonate (PC), wherein the polycarbonate (PC) has a weight ratio of 15-60% in the starch-based thermoplastic composite; and
acrylonitrile butadiene styrene (ABS).

2. The starch-based thermoplastic composite as claimed in claim 1, wherein the enzyme-degraded thermoplastic starch (TPS) has a debranching rate of 40-60%.

3. The starch-based thermoplastic composite as claimed in claim 1, wherein the enzyme-degraded thermoplastic starch (TPS) has a weight ratio of 10-70% in the starch-based thermoplastic composite.

4. The starch-based thermoplastic composite as claimed in claim 1, wherein the enzyme-degraded thermoplastic starch (TPS) has a weight ratio of 10-35% in the starch-based thermoplastic composite.

5. The starch-based thermoplastic composite as claimed in claim 1, wherein 95% of the enzyme-degraded thermoplastic starch (TPS) has a particle size less than 1.5 μm.

6. The starch-based thermoplastic composite as claimed in claim 1, wherein the polycarbonate (PC) has a weight ratio of 30-45% in the starch-based thermoplastic composite.

7. The starch-based thermoplastic composite as claimed in claim 1, wherein the acrylonitrile butadiene styrene (ABS) has a weight ratio of 15-60% in the starch-based thermoplastic composite.

8. The starch-based thermoplastic composite as claimed in claim 1, wherein the acrylonitrile butadiene styrene (ABS) has a weight ratio of 30-45% in the starch-based thermoplastic composite.

9. The starch-based thermoplastic composite as claimed in claim 1, further comprising an impact modifier.

10. The starch-based thermoplastic composite as claimed in claim 9, wherein the impact modifier comprises metallocene-based polyethylene (MPE), polypropylene (PP), poly(butadiene-styrene) (PBS), thermoplastic polyurethane (TPU), styrene-ethylene/butylene-styrene (SEBS), styrene-ethylene/propylene-styrene (SEPS), methacrylated butadiene-styrene (MBS), thermoplastic elastomers (TPE), high-rubber content acrylonitrile butadiene styrene (ABS), polycarbonate (PC) or a combination thereof

11. The starch-based thermoplastic composite as claimed in claim 9, wherein the impact modifier has a weight ratio of 2-45% in the starch-based thermoplastic composite.

12. The starch-based thermoplastic composite as claimed in claim 9, wherein the impact modifier has a weight ratio of 5-30% in the starch-based thermoplastic composite.

13. The starch-based thermoplastic composite as claimed in claim 1, further comprising a compatibilizer.

14. The starch-based thermoplastic composite as claimed in claim 13, wherein the compatibilizer comprises polyethylene-g-maleic anhydride (PE-g-MA), polyethylene-g-glycidyl methacrylate (PE-g-GMA), ethylenevinylacetate-g-maleic anhydride (EVA-g-MA), polypropylene-g-maleic anhydride (PP-g-MA), polystyrene-g-maleic anhydride (PS-g-MA), acrylonitrile butadiene styrene-g-maleic anhydride (ABS-g-MA), styrene maleic anhydride (SMA), polycarbonate (PC) or a combination thereof.

15. The starch-based thermoplastic composite as claimed in claim 13, wherein the compatibilizer has a weight ratio of 0.1-20% in the starch-based thermoplastic composite.

16. The starch-based thermoplastic composite as claimed in claim 13, wherein the compatibilizer has a weight ratio of 3-7% in the starch-based thermoplastic composite.
